(19) United States
(12) Patent Application Publication
(10) Pub. No.: US 2002/0048109 A1
(43) Pub. Date: Apr. 25, 2002

(54) dB linear variable gain amplifier

(76) Inventors: Alan I. Chaiken, Chandler, AZ (US); Mark J. Chambers, Gilbert, AZ (US); Jose O. Perez, Tempe, AZ (US)

Correspondence Address: TEXAS INSTRUMENTS INCORPORATED, P O BOX 655474, M/S 3999, DALLAS, TX, 75265

(21) Appl. No.: 09/943,289

(22) Filed: Aug. 30, 2001

Related U.S. Application Data
(60) Provisional application No. 60/241,641, filed on Oct. 19, 2000.

(51) Int. Cl. G11B 5/02

(52) U.S. Cl. 360/67

(57) ABSTRACT

A dB gain amplifier for providing a levelized output signal includes a first transconductance circuit to output a first current in a first current path, a second transconductance circuit to output a second current in a second current path, a first current mirror to control the first current in the first current path, a second current mirror to control the second current in the second current path, and a DAC circuit to control the first and second current mirrors piecewise linearly.

### FIELD OF THE INVENTION

The present invention is related to circuits and methods of generating variable voltage gain amplification of an input signal and, more particularly, to circuits and methods for precisely controlling voltage gain over a broad bandwidth of an input signal.

### BACKGROUND OF THE INVENTION

Variable gain amplifiers (VGAs) are employed in many applications in order to maximize the dynamic range of the overall system. The VGA is typically employed in a feedback loop to realize automatic gain control (AGC). AGC circuits are an essential part of many systems. In disk drives, the AGC forms an essential component of the read channel as it stabilizes the voltage supplied to the detector and filter section of the read channel.

In modern hearing aids, the AGC plays an important role in adopting the processing signal to hearing-loss characteristics and offers an improvement of speech intelligibility. An AGC is also an important element in virtually all portable communication systems. Receiver portability implies that the receiver may be very close to the transmitter, thus receiving a strong signal, or far away, receiving a weak signal. The function of the AGC loop is to automatically adjust the gain of the receive path so that the signal processed by the baseband circuitry appears to be of a constant level regardless of the actual signal size received at the antenna. Digital AGCs may be employed in cable TV modems.

Many of the above mentioned applications are mixed analog/digital in nature, where the analog signal is finally converted to a digital form. Once in the digital world, more complex and precise processing can be achieved using various digital circuitry and DSP software techniques. Therefore, the AGC usually employs a part of the digital portion of the chip in the feedback loop. This has been demonstrated in a number of mixed-signal systems.

In magnetic disk storage systems for computers, digital data serves to modulate the current in a read/write head coil so that a sequence of corresponding magnetic flux transitions are written onto a magnetic medium in concentric tracks. To read this recorded data, the read/write head passes over the magnetic medium and transduces the magnetic transitions into pulses in an analog signal that alternate in polarity. These pulses are then decoded by read channel circuitry to reproduce the digital data.

Certain applications, however, require a variable gain CMOS amplifier which has an exponential (linear in dB) gain control characteristic over a prescribed range. The amplifier should be able to handle reasonably large signals with reasonably low distortion and have very low input noise. One further example of an application is a variable gain amplifier for preconditioning CCD signals in a camcorder, where the variable gain amplifier is used to maintain an acceptable signal level input to an analog-to-digital converter.

In one prior art approach, a standard differential pair with a variable tail current is used to drive a pair of diode-connected devices, also with variable bias current. If the bias is arranged to that the current in one pair increases as the current in the other pair decreases, the resulting voltage gain has the form: gain=sqrt ((1+x)/(1−x)). Over a limited range, this expression is a good approximation to an exponential. However, this design has drawbacks. Because current control of transconductance is used, the gain is limited by the square root nature of the device to a fairly small range. Also, the signal path linearity is not great unless large gate-to-source voltages are used. However, the gain of such a circuit is not always exactly exponential in nature. Thus, it is desirable to have a response which more closely matches the characteristics of the gain.

### SUMMARY OF THE INVENTION

The present invention provides a dB linear variable gain amplifier having a response which more closely matches the gain of the variable gain amplifier where the gain equals sqrt ((1+x/l)/(1−x/l)). The present invention includes a digital-to-analog converter which is coupled to a current source to add or subtract current from two current paths of a dB linear variable gain amplifier. The present invention provides a circuit that adjusts the bias current and does not degrade the bandwidth. The present invention employs two current mirrors in each leg of two current paths to adjust the bias current. The biased current is adjusted using a piecewise linear digital-to-analog converter. The piecewise linear current uses a first low slope in a first region, a second higher slope in a second region, and again, a third low slope in a third region.

### BRIEF DESCRIPTION OF THE DRAWINGS

FIG. 1 illustrates a read channel block diagram in incorporating the teachings of the present invention;

FIG. 2 illustrates the transfer characteristics of the DAC used in conjunction with the AGC of the present invention;

FIG. 3 illustrates in more detail the circuit of the present invention;

FIG. 4 illustrates a composite of transfer characteristics;

FIG. 5 illustrates a side view of a disk drive system; and

FIG. 6 illustrates a top view of a disk drive system.

### DETAILED DESCRIPTION OF THE PRESENT INVENTION

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

FIGS. 5 and 6 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 1116 and the actuator shaft 1130 are attached to the chassis 1120. A hub assembly 1132 rotates about the actuator shaft 1130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 1112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The AE unit 1192 includes a printed circuit board 1193, or a flexible carrier, mounted on the actuator arms 1134 or in close proximity thereto, and an AE module 1194 mounted on the printed circuit board 1193 or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152. The read/write channel 1190 includes the variable gain amplifier 100 of the present invention.

Turning to FIG. 1, the analog input signal read from the disk is input to the variable gain amplifier 100. The variable gain amplifier 100 attempts to maintain a levelized output signal based on a variable analog input signal. The output of the variable gain amplifier is output to the read channel analog front end 102. Here, the read channel analog front end 102 performs various initial processing. The read channel analog front end 102 is connected to and outputs a processed output signal to A/D converter 104 which converts the analog signal to a digital signal. The output of the A/D converter 104, the digital signal, is output to the read channel digital detector 106 for further read channel processing. Additionally, the output of the A/D converter 104 is input to the digital automatic gain control 108 which determines the amount of gain for the variable gain amplifier 100. The digital automatic gain control circuit 108 outputs an AGC word to indicate the amount of adjustment necessary to differential digital-to-analog converter 110 which outputs a differential output current which is piecewise linear to the variable gain amplifier 100.

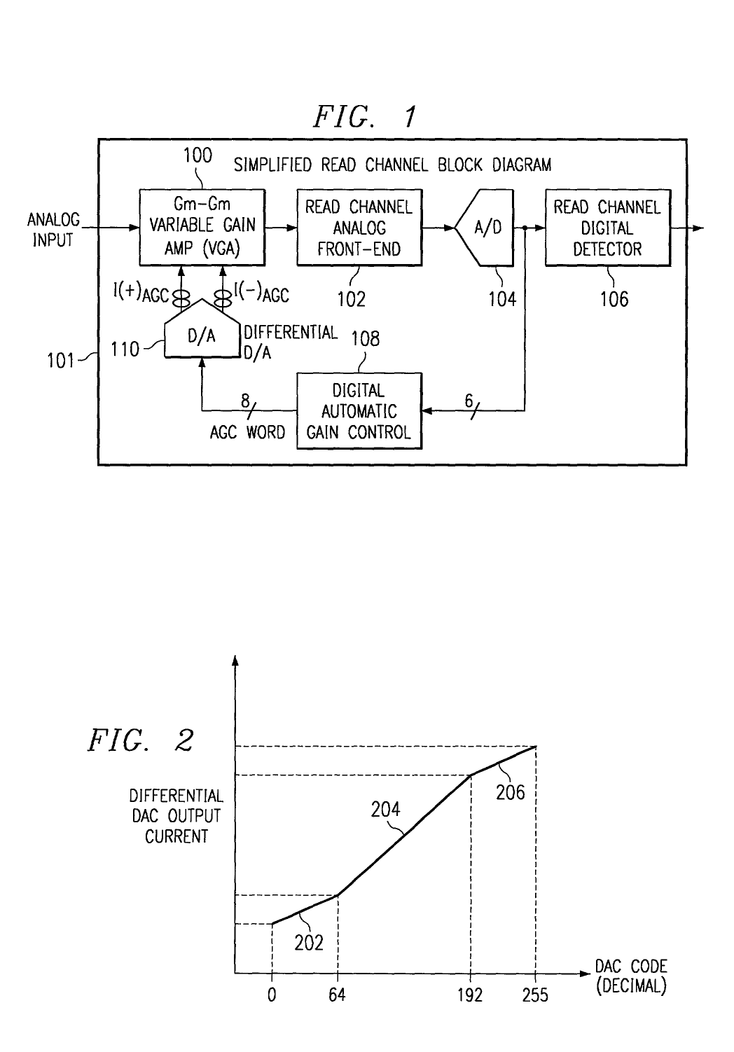

FIG. 2 illustrates a curve of the digital-to-analog code which is output from the digital automatic gain control circuit 108 and the input from the differential D/A converter. This curve is piecewise linear. For example, if the DAC code is between zero and 64, the output current follows a first low slope, curve 202, in the first region. Curve 202 increases at a first rate. If the DAC code word is between 64 and 192, DAC output current follows curve 204 at a second higher slope in the second region from the differential D/A converter 110. Lastly, if the DAC code is between 192 and 255, the differential output current follows curve 206. Curve 206 is at a third lower slope in the third region than either curve 202 or curve 204.

FIG. 3 illustrates a circuit of the present invention. FIG. 3 illustrates a first current path 303 and a second current path 311. Additionally, FIG. 3 illustrates a first current mirror 330 for the first current path 303 and illustrates a second current mirror 332 for the second current path 311. Additionally, the digital-to-analog converter 110 is connected to and controls both the first current mirror 330 and the second current mirror 332. The DAC increases or decreases the first and second curves in the first and second current paths. The first current mirror includes NFET 316 and NFET 317. The first current path is connected to the drain of NFET 316 while the source of NFET 316 forms a portion of the first current path. Additionally, the gate of NFET 316 is connected to the gate and drain of NFET 317. The drain and gate of NFET 317 is connected to the inverse output of digital-to-analog converter 110. The current mirrors 330 and 332 operate such that, for example, current mirror 330 maintains the same current through the drain-to-source of transistor 317 as the current through the drain-to-source of NFET 316. Likewise, with NFET 315, the current flowing from source-to-drain of NFET 315 is the same as the current through the drain-to-source of NFET 314. Additionally, connected to current source 330 is transconductance circuit 334, and connected to current mirror 332 is transconductance element 336. The transconductance circuit 334 includes NFET 302 and NFET 304. The source of NFET 302 is connected to the source of NFET 304 while the drain of NFET 302 is connected to current source 308, and the drain of NFET 304 is connected to the drain of NFET 302 and to current source 306. The gates of NFET 302 and 304 receive the differential inputs which are output from the read head and through intervening circuit such as a preamplifier (not shown). The output of transconductance circuit 334 is current I+x, and the output from transconductance circuit 336 is I−x. The digital-to-analog converter 110 outputs a piecewise linear output as described hereinabove. The slope or rate of change for a change in AGC word varies depending on the region corresponding to the particular AGC word. The word is changed dynamically as the circuit 100 is operated. As a consequence, the dB curve is more closely matched. The bandwidth of the VGA 100 is not degraded as a result of adjusting the bias current by current mirror 330 and current mirror 332. The low impedance transistors, namely NFET 310 and NFET 312, output a maximum bandwidth voltage V_{OUTP} and voltage V_{OUTM}.

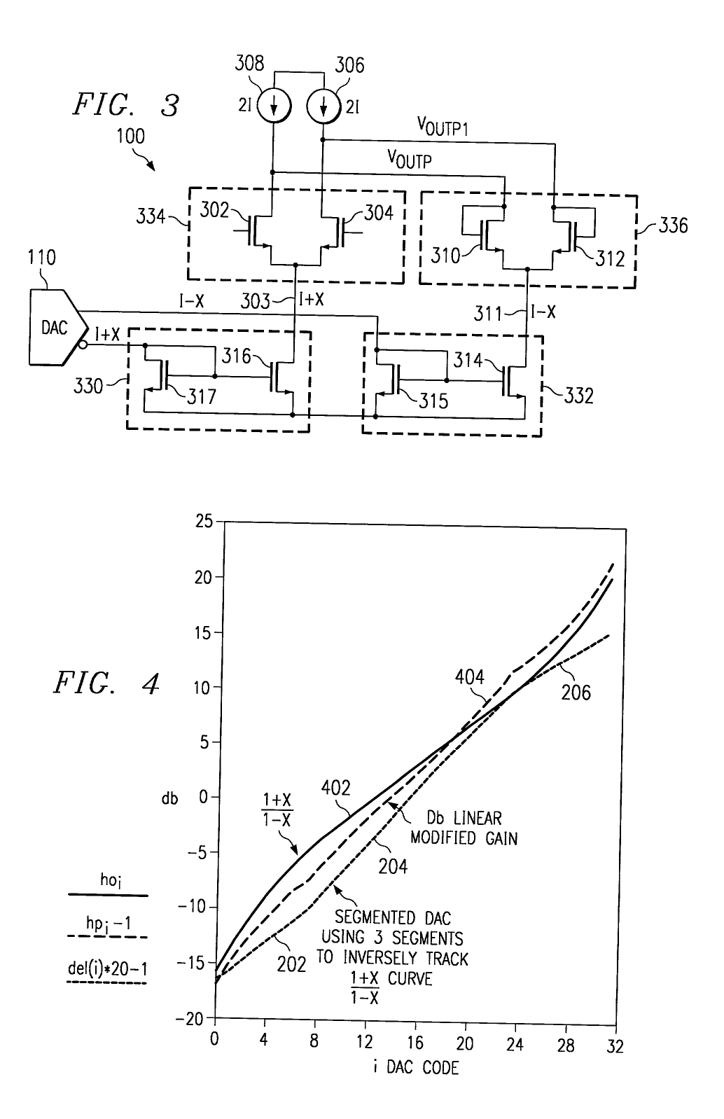

FIG. 4 illustrates the relationship between the piecewise linear output characteristics, namely curves 202, 204 and 206, with the gain proportional to 1+x/1−x in curve 402. Curve 404 illustrates the modified dB linear modified gain as produced by the present invention.

1. A dB gain amplifier for providing a levelized output signal, comprising:
a first transconductance circuit to output a first current in a first current path;
a second transconductance circuit to output a second current in a second current path;
a first current mirror to control the first current in said first current path;
a second current mirror to control the second current in said second current path; and
a DAC circuit to control the first and second current mirrors piecewise linearly.

2. A dB gain amplifier, as in claim 1, wherein said DAC circuit controls said first and second current mirrors by changing the slope of response for said first and second current mirrors.

3. A disk drive system, comprising:
a head to read/write information on a disk;
a preamplifier to amplify the information read by said head; and
a read channel to process said information;
wherein said read channel includes a dB gain amplifier for providing a levelized output signal, said dB gain amplifier including:
a first transconductance circuit to output a first current in a first current path;
a second transconductance circuit to output a second current in a second current path;
a first current mirror to control the first current in said first current path;
a second current mirror to control the second current in said second current path; and
a DAC circuit to control the first and second current mirrors piecewise linearly.

4. A disk drive system, as in claim 3, wherein said DAC circuit controls said first and second current mirrors by changing the slope of response for said first and second current mirrors.
